(19) United States
(12) Patent Application Publication
(10) Pub. No.: US 2004/0053576 A1
(43) Pub. Date: Mar. 18, 2004

(54) Device for optimising a transmitter in accordance with transmission conditions, and reference receiver and transmitter for use in said device

(76) Inventors: Pierre Vasseur, Maule (FR); Bruno Le Breton, Boulogne (FR)

Correspondence Address: LOWE HAUPTMAN GILMAN & BERNER, LLP, 1700 DIAGNOSTIC ROAD, SUITE 300, ALEXANDRIA, VA, 22314, US

(21) Appl. No.: 10/432,284

(22) PCT Filed: Nov. 20, 2001
(86) PCT No.: PCT/FR01/03644

(30) Foreign Application Priority Data
Nov. 21, 2000 (FR) 00 15017

(51) Int. Cl. H04B 1/10; H04B 15/00; H04B 17/00

(52) U.S. Cl. 455/63.1; 455/67.11; 455/67.13

(57) ABSTRACT

The invention concerns the adaptation of a transmission system to the transmission conditions.

A device for optimizing a transmitter comprises at least an element used to evaluate, depending on the quality indicator(s) received, the optimization necessary for at least one parameter of said transmitter, in particular of at least one element of its transmission system.

In addition, the broadcasting system comprises at least: one transmitter receiving optimized parameters used to adjust the parameters of at least one element of its transmission system and transmitting a signal with at least one audio program and the configuration of its transmission system,

one reference receiver receiving the signal transmitted by said transmitter and supplying a signal containing at least one quality indicator, and an optimization device receiving said signal with quality indicator and supplying the adjustment parameters to said transmitter.

The invention concerns the adaptation of a transmission system to the transmission conditions.

For example, during the transmission of a radio broadcast in the AM bands and, in particular, in short wave, the signal propagation conditions vary constantly. Consequently, reception is disturbed, even non-existent.

In order to optimize reception the broadcasters plan different frequencies depending on the time of year, the time of day and the solar activity, when this can be predicted.

This phenomenon exists in analogue radio but it is more disturbing in digital radio. Although corrector codes (channel encoding) correct a certain number of transmission errors, in fact, above an error threshold the decoding becomes inoperative and the audio signal disappears.

This invention is used to prevent, or at least reduce, these disadvantages by optimizing various elements of the transmission system to the propagation conditions, especially by adapting the transmitter power and channel encoding parameters. This will ensure the best possible quality of service at all times for a given frequency in a defined reception area.

The invention concerns a device designed to optimize a transmitter, wherein it comprises:

at least one input connected to a communication network receiving a signal including at least one parameter indicating the reception quality of a signal transmitted by said transmitter;

at least one element used to evaluate, depending on the quality indicator(s) received, the optimization necessary for at least one parameter of said transmitter, in particular of at least one element of its transmission system;

at least one output connected directly or indirectly to said transmitter, on which the optimized parameter(s) are supplied.

Furthermore, the invention also concerns a transmission system comprising at least one transmitter, at least one receiver, and an optimization device connected to a communication network, receiving at least one quality indicator from the receiver used to supply at least one optimized parameter and transmit it to the transmitter.

A variant of the invention is a transmission system comprising at least:

a transmitter receiving optimized parameters used to set the parameters of at least one element of its transmission system and transmitting a signal with at least one program and the configuration of its transmission system,

a receiver, for example a general public receiver, receiving the signal transmitted by said transmitter and replicating at least one program contained in said received signal,

a reference receiver receiving the signal transmitted by said transmitter and supplying a signal containing at least one quality indicator, and

an optimization device receiving said signal with quality indicator and supplying the parameters to set said transmitter.

In this latter transmission system, the following are possible:

either each receiver used to replicate the program received can also supply at least one quality indicator,

or the receiver and the reference receiver are two separate devices, the first being used to replicate the program received and the second being a signal sensor that can supply at least one quality indicator.

The advantages and features of the invention will be clearer on reading the following description, given as an example, illustrated by the attached figures representing in:

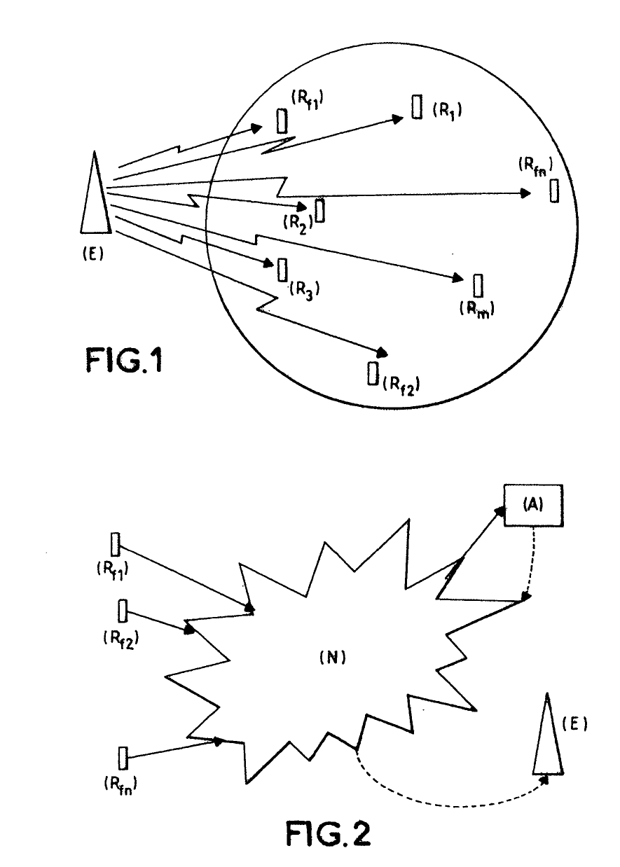

FIG. 1, a representation example of the broadcasting system according to the invention,

FIG. 2, a realization example of the broadcasting system with transmission optimization according to the invention,

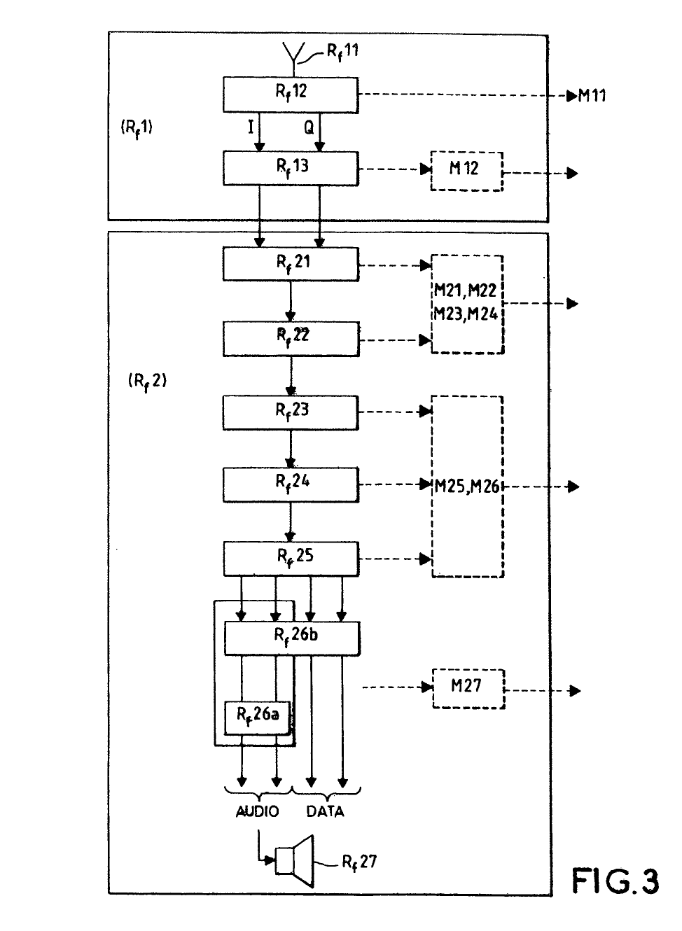

FIG. 3, a realization example of reference receiver according to the invention,

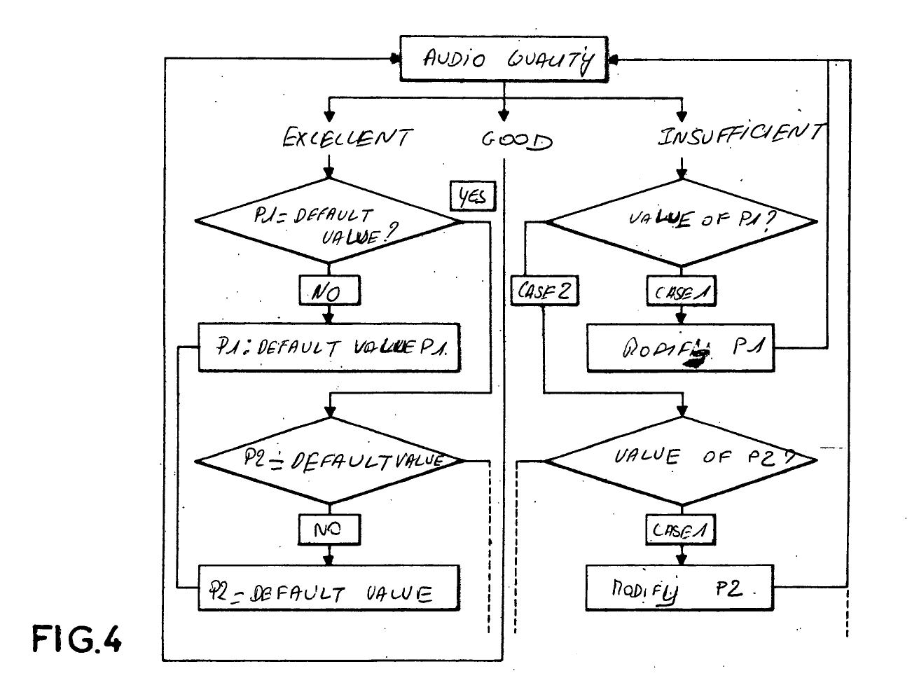

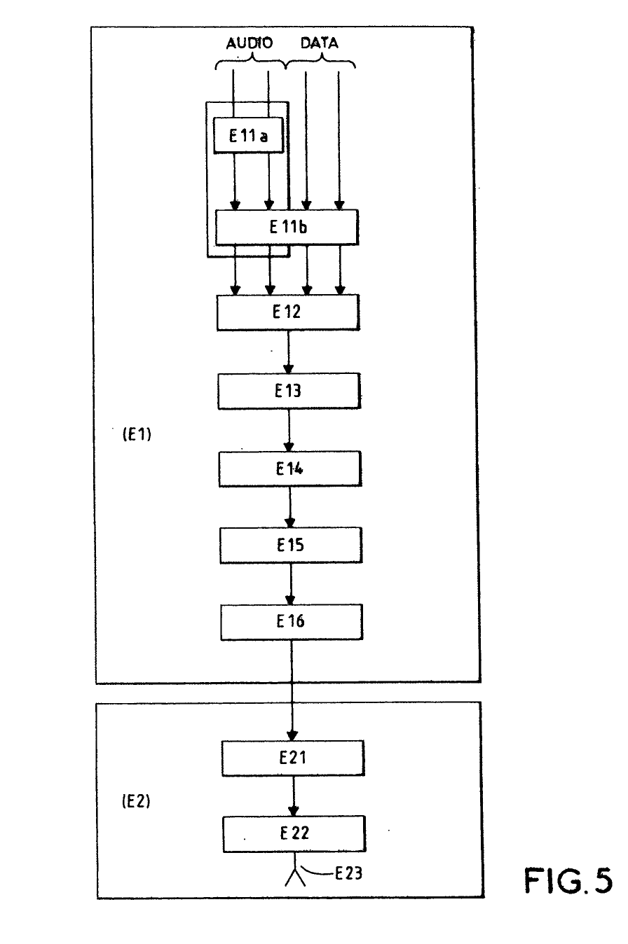

FIG. 4, an operation example of the optimization device according to the invention,

FIG. 5, a realization example of an optimizable transmitter according to the invention.

In the remainder of the description, the system according to the invention will be described in the context of broadcasting radio programs in the AM bands. This system can be considered for radio broadcasting no matter what frequency band is used.

FIG. 1 shows that the broadcasters have target areas to broadcast their programs. The broadcaster's transmitter E, in fact, transmits towards a predetermined target area. All receivers (R₁ . . . Rₘ, R_{f1} . . . R_{fn}) in this area pick up the programs broadcast by the transmitter with more or less good quality. “Reference” receivers (R_{f1} . . . R_{fn}) are deployed in this area. They can analyze the signal received and the integrity of its content.

On FIG. 2, the reference receivers (R_{f1} . . . R_{fn}) transmit this pre-analysis to an optimization device A including at least one signal processing system. This optimization device A can be located more or less close to the transmitter E, or even included in the transmitter E—the latter configuration is not shown on the figure—. The optimization device A collects information generated by the receiver(s) R_{f}. Then, it produces a summary of the measurements taken. By applying index values, it remotely controls the adjustment parameters of the transmitter E, especially the transmission system. Transmission of measurements from the reference receivers R_{f} to the optimization device A and, if necessary, transmission of optimized parameters from the optimization device A to the transmitter E can be made, for example, on a wire network (telephone, Ethernet, etc.) or wireless network (telephone, satellite, etc.).

FIG. 3 shows a realization example of a reference receiver R_{f} adapted to receive the signal broadcast, i.e. it includes at least the elements (for example demodulator and/or decoder and/or de-interlacer, etc.) required to retrieve the program(s) transmitted in the signal broadcast. The reference receiver R_{f} is therefore used to demodulate the multicarrier constellation, to perform channel decoding, to demultiplex the beam (for example DRM (Digitale Radio Mondiale) type), to decode the audio and data beams and perform real time analysis using suitable means C (represented on FIG. 3 in dotted lines) supplying measurements M. During this analysis, various measurements can be taken throughout the entire reception system.

For example, the signal broadcast is received on antenna R_{f}11 of the reception device R_{f}1 of the receiver R_{f}. The signal then crosses a module R_{f}l2 called RF Front End. At this stage, a first measurement M11 can be taken on the level of the signal received. The signal then enters a filter bringing it back into base band R_{f}13. At this stage, a second measurement M12 can be considered such as for example on the frequency mask or a spectral analysis.

The signal is then processed by the reception system R_{f}2. For example, this system includes in series a demodulator R_{f}21, a Deframer R_{f}22, a de-interlacer R_{f}23, a channel decoder R_{f}24, a demultiplexer R_{f}25, a source decoder R_{f}26 possibly including an audio decoder R_{f}26a, and one or more program replication devices (such as for example a loudspeaker R_{f}27 for the audio and/or data programs, and/or a screen not shown to display the data, etc.).

At the demodulator R_{f}21 and/or the Deframer R_{f}22, measurements can be taken on the constellation M21, on the signal to noise ratio (SNR) M22, statistics (for example, the mean and/or distribution on the constellations, the SNR, the paths) M23, and/or measurements on the paths (numbers, amplitudes, positions, etc.) M24. At the de-interlacer R_{f}23, the channel decoder R_{f}24 and/or the demultiplexer R_{f}25, the error rates M25 such as the MER (Mean Error Rate) and/or the bit error rate (BER) M26 can be measured. At the source decoder R_{f}26, the analysis may supply a measurement M27 of audio quality, if it is an audio program, or more generally the data quality.

Summing up, the reference receiver R_{f} has one or more of the following functions:

the indication of the received signal level,

the BER measurement,

the base band input signals I and Q (IQ levels),

the input spectrum.

the channel pulse response and the channel gain on frequency,

the demodulated constellation with the associated symbol signal to noise ratio,

the audio outputs,

the signal to noise ratio on reference frequencies,

the possibility of saving data and repeating it, at various points in the reception system,

the stored file repetition function,

the fully automatic log book function,

the histogram function on the main technical parameters saved,

the graphic tools for visual analysis of the transmission parameters,

the statistical analysis of the main parameters,

the automatic reconfiguration on line or via an internal programmable plan.

The possible uses of the reference receiver R_{f} include, for example:

monitoring and/or display of the received signal, locally or remotely,

real time display, measurements and analysis on line of the technical parameters of the received signal,

saving the information, for example on a hard disk, for more in depth analysis carried out later, i.e. by the optimization device A,

use as training tools for the personnel to prepare the transition from analog to digital.

The optimization device A receives the measurements M taken by the various reference receivers in the target area of transmitter E to which it is associated. It summarizes these results, for example by comparing the values received with minimum and/or maximum thresholds set by the broadcaster depending on the minimum reception quality required. For example, when the minimum threshold is exceeded, the optimization device A can react by increasing the channel encoding. When one or more minimum thresholds are crossed, the channel encoding is therefore reduced. The various thresholds (index values) may be predefined or set by the transmission network operator.

The measurements received may include, for example, one or more of the following:

the audio quality (scale, etc.)

the received field level (distribution, mean, etc.)

the signal to noise ratio at several points on the reception system (mean, distribution, etc.)

the channel pulse response (amplitudes, position, number of paths, Doppler effect, etc.)

FIG. 4 shows, as an example, a flowchart implementing the optimization method of the optimization device A. In this case, one of the measurements received by the optimization device A, in this case the audio quality, is examined first.

If it is greater than a threshold set by the broadcaster, it is said to be “excellent”. In this case, all parameters are examined to check whether they correspond to their default values. Otherwise, they are:

either changed directly to their default values one by one as shown on the flowchart or all together,

or, if possible, assigned to an intermediate value, again one by one or all together.

For example, if the transmitted power is greater than the default value, the channel encoding used is very powerful, and if the audio quality is excellent, the optimization device can, for example:

either set the transmitted power to its default value and wait and see how the audio quality changes,

or reduce the transmitted power by a fixed increment towards its default value and wait and see how the audio quality changes,

or command the use of the default channel encoding and wait and see how the audio quality changes,

or command the use of channel encoding less powerful but still more powerful than the default channel encoding and wait and see how the audio quality changes,

or act both on the transmitted power and the channel encoding.

As shown on FIG. 4, if the parameters are optimized separately the various parameters can have different weights, so that the optimization device will be able to examine them in the order of their weights. For example, if the weight of the transmitted power parameter P1 is greater than that of the channel encoding P2, the optimization device first checks whether the transmitted power P1 has its default value. If it does not, it modifies the transmitted power parameter P1. If the transmitted power has its default value, it examines the next parameter P2 . . . It would be possible to examine several parameters which have been assigned the same weight.

If the audio quality is deemed “insufficient”, the optimization device considers various hypotheses regarding the reason for the drop in audio quality. For example, it will examine the behavior of a certain number of measurements, dependently or independently. The order in which the various measurements are examined can be given by assigning, once again, a weight to each measurement. In the case described on the flowchart of FIG. 4, it examines the behavior of a first measurement with respect to a threshold set by the broadcaster. For example, the received signal level M11 with respect to a minimum threshold. In case 1, i.e. in this case if the level is less than the threshold, the parameter concerning the transmitted power is increased and/or the transmission direction (the azimuth, the direction of the transmission antenna) is modified. In case 2, i.e. in this case if the received signal level is greater than the threshold, a second measurement is examined. For example, the bit error rate M25 is compared with a maximum threshold. In case 1, i.e. in this case if the error rate is greater than the threshold, parameter P2 concerning the channel encoding is modified in order to use more powerful channel encoding. Instead of modifying the parameters one by one, it would be possible to modify one or more parameters to a greater or lesser extent (weighting of the setting according to the measurements) depending on the comparison of one or more measurements obtained with respect to their respective thresholds.

The configuration optimization carried out by the optimization device A may, for example, be such that:

the loss of audio quality results in modification of the channel encoding and/or of the modulation and/or of the multiplexing (for example, deletion of some programs) used with interaction on the source encoding because of the useful speed,

the loss observed on the pulse response or on the signal to noise ratio results in modification of the channel encoding and/or the mode (Ground, SKYWAVE, Robust) used with interaction on the source encoding because of the useful speed.

In addition to these adjustments on the transmission system E1 of the transmitter E, adjustments could be carried out on the transmission device E2. In particular, the optimization device can be used to optimize the adjustment of the transmitted power, transmission frequency and transmission antenna direction parameters, etc.

To reduce the volume of measurements transmitted to the optimization device, it would be possible to only analyze these measurements periodically. The optimization device A includes at least a means of synchronizing all measurements received from the various reference receivers R_{f}.

After modifying certain parameters, it may be necessary to adapt other parameters of the transmitter E. For example, if parameter modification causes a change in the useful speed, when the signals have a high level of protection, the optimization device A which slaves the transmitter E also acts on the adjustment of the audio encoder(s) to adapt the speed supplied to the useful speed available at this time.

As an example, for a transmission in an HF channel with a radio frequency passband of 9 kHz, when the conditions are “ideal”, the useful speed is about 25 kbits/s with modulation 64 QAM. If the propagation conditions worsen: reduction of the signal to noise ratio and/or increase of the bit error rate, the transmission mode can be changed to offer better protection of the useful content, switching from Ground mode to SKYWAVE mode (these modes define the OFDM (Orthogonal Frequency Division Multiplexing) structure specific to DRM). The useful speed is therefore reduced to 19 kbits/s. The source encoding is reconfigured to change the speed from 25 to 19 kbits/s. The optimization device A sends the optimized parameters to the transmission system which will apply them to the source encoder, to the channel encoder and to the modulator.

If the conditions deteriorate, the optimization device will command the switch into 16 QAM without Reed Solomon (RS) encoder. The useful speed is therefore about 18 kbits/s and the source encoder will be optimized accordingly.

The optimization device A can also command the switch into robust mode with a useful speed of 16 kbits/s, etc.

The following table indicates, as an example, the useful speeds in bits/s depending on the protection level of a 9 kHz channel:

| | Ground | | |
|---|---|---|---|
| | mode | SKYWAVE mode | Robust mode |
| 64QAM, without RS | 27720 | 22000 | 17360 |
| 16QAM, without RS | 18480 | 14640 | 11580 |
| QPSK, without RS | 10260 | 8120 | 6440 |
| 64QAM, with RS | 25080 | 19380 | 15960 |
| 16QAM, with RS | 17970 | 13980 | 11400 |
| QPSK, with RS | 9690 | 7410 | 6000 |

The source encoder is reconfigured to supply the useful speed adapted to the protection obtained by optimization of the transmission system parameters via the optimization device A.

The parameters so optimized are transmitted to the transmitter E to adjust the various adjustable parameters, in particular the transmission system parameters but also, if necessary, the transmission device parameters as shown on FIG. 5.

Source encoding E11 of the audio and/or data programs is carried out, including at least compression E11b of the digital signal. The source encoder used E11 is determined by the parameters transmitted by the optimization device A. Then, the various programs are multiplexed E12 depending on the multiplexing parameter determined also by the optimization device A. The signal obtained undergoes channel encoding E13, interlacing E14, formatting as packets E15 and modulation E16. Each of these functions is configured by the optimized parameters supplied by the optimization device A. Possibly, the parameters of the transmission device E2 are adjusted by parameters optimized also by the optimization device A. This is used to modify the synthesizer E21 implemented (transmission frequency), the transmitted power with device E22 and/or the direction of the transmission antenna E23.

The possible modulations include, for example, QAM (Quadrature Amplitude Modulation) on 8, 16, 64 states or QPSK (Quadrature Phase Shift Keying). The possible channel encoding may be, for example, MLC (Multi level Coding) and/or RS (Reed Solomon) encoding. The possible audio source encoding may be, for example, MPEG-4 AAC (Advanced Audio Coding) or MPEG-4 AAC and SBR (Spectral Band Replication) or MPEG-4 AAC and PAT (Perceptual Audio Transposition) or G729 (CCETT) or CELP or MPEG 2 layer 3.

This method can operate in almost real time in order to guarantee optimum quality at all times. The receiver R_{f} receives the information on the transmitter adjustment in the broadcast signal received and adapts automatically.

In the previous examples, the signal includes one or more audio programs and/or one or more data programs. The signal may also include alone or together with one or more of the previous programs one or more programs containing fixed images. This system can be used for broadcasting according to the DRM standard, and more generally for broadcasting according to standard UIT217-1/10/Union Internationale des Télécommunications.

In addition, the use of this transmission system or at least one of its constituent devices must not be limited to the AM bands but can also be used, for example, for the FM bands, etc.

Generally, the optimization device A receives one or more signals each including one or more measurements indicating the quality of the signal received in a broadcasting system and from one or more receivers R. These receivers R may be special receivers, called reference receivers R_{f}. The signals including the measurements or quality indicators are transmitted either via a wire network (telephone network or Ethernet, etc.) or via a wireless network (mobile telephony network, satellite, etc.). These signals may, for example, be transmitted on request from the optimization device A or periodically at instants defined for each reference receiver R_{f}.

The optimization device A may consider one or more measurements to modify one or more parameters. It therefore provides a means of maintaining fixed reception quality when the transmission conditions deteriorate and allows the transmitter E to use less powerful devices (lower transmitted power, less powerful channel encoding, etc.) when the transmission conditions are satisfactory. The parameters of the transmitter E so optimized by the optimization device A are now used to adjust the various elements of the transmitter E, in particular the transmission system so that they adapt to the transmission conditions

The device A can carry out an analysis either on an event generated by a reference receiver or on the basis of cyclic analysis whose frequency can be predetermined or set by the operator.

The device A can therefore be used to command the adjustment either of the elements of the transmission system E1 only, or the elements of the transmission device E2 only, or the elements of the transmission system E1 and of the transmission device E2.

The configuration of the transmitter E is transmitted with the programs in the signal broadcast. The receivers can therefore reconfigure their devices (OFDM modes, demodulator, demultiplexer, channel decoder, source decoder, etc.) accordingly.

1. Device for optimizing the operation of a transmitter (E), wherein it comprises:
at least one input connected to a communication network (N) receiving a signal including at least one parameter (P) indicating the reception quality of a signal transmitted by said transmitter (E);
at least one element used to evaluate, depending on the quality indicator(s) received, the optimized parameter(s) corresponding to the optimization necessary for at least one parameter of said transmitter (E), in particular of at least one element of its transmission system (E1);
at least one output connected directly or indirectly to said transmitter (E), on which the optimized parameter(s) are supplied.

2. Optimization device, wherein the quality indicators come from at least some of the receivers, called reference receivers (R_{f}), via a network (N).

3. Optimization device according to claim 1 or 2, wherein the quality indicator(s) are one or more of the following parameters:
mean signal to noise ratio of the constellation,
distribution of the signal to noise ratio of the constellation,
amplitude of the received field,
audio quality,
number of paths,
amplitudes and positions of one, several or all of the paths,
Doppler effect.

4. Optimization device according to one of the previous claims, wherein the optimized parameter(s) are one or more of the following parameters:
the modulation type,
the OFDM configuration,
the DRM mode,
the type of error detector and/or corrector encoder,
the transmitted power,
the transmission direction.

5. Transmitter comprising:
a transmission system (E1) comprising several elements including at least:
a source encoder (E11) receiving at least an audio program or a data program, and
a modulator (E16), and
a transmission device (E2) comprising at least one antenna (E23), wherein at least one of its parameters, called adjustable parameters, can be modified.

6. Transmitter according to the previous claim, wherein the modified parameter(s) are at least one parameter of at least one element in its transmission system (E1).

7. Transmitter according to claim 5 or 6, wherein it comprises at least one input connected to a communication network (N) connected to an optimization device (A) supplying the optimized parameters which are used to modify said adjustable parameters.

8. Transmitter according to the previous claim, wherein said optimization device (A) is an optimization device according to claim 1 or 2.

9. Transmitter according to claim 5 or 6, wherein it comprises at least one optimization device (A) according to claim 1 or 2 supplying the optimized parameters which are used to modify said adjustable parameters.

10. Receiver, wherein it receives the signal transmitted by the transmitter (E) according to one of claims 5 to 9.

11. Receiver according to the previous claim, wherein it comprises at least a means (C) to analyze the received signal quality that can supply one or more quality indicators.

12. Transmission system comprising at least one transmitter (E) and at least one receiver (R), wherein it comprises an optimization device (A) connected to a communication network (N), receiving at least one quality indicator from the receiver (R) used to supply at least one optimized parameter and transmit it to the transmitter (E).

13. Transmission system comprising at least:
one transmitter (E) according to one of claims 5 to 9, receiving optimized parameters used to adjust the parameters of at least one element of its transmission system (E1) and transmitting a signal with at least one program and the configuration of its transmission system,
one reference receiver (R_{f}) according to claim 11 receiving the signal transmitted by said transmitter (E) and supplying a signal containing at least one quality indicator, and
one optimization device (A) according to one of claims 1 to 4 receiving said signal with quality indicator and supplying the adjustment parameters to said transmitter (E).

14. Transmission system according to the previous claim comprising at least one receiver (R) according to claim 10 receiving the signal transmitted by said transmitter (E) and replicating at least one program contained in said received signal.

15. Use of the transmission system according to claim 12 or 14 for AM broadcasting.

16. Use of the transmission system according to claim 12 or 14 for broadcasting according to the DRM standard or broadcasting according to standard UIT217-1/10.
